(19) United States
(12) Patent Application Publication
(10) Pub. No.: US 2021/0037108 A1
(43) Pub. Date: Feb. 4, 2021

(54) SYSTEMS AND METHODS FOR DATA STORAGE

(71) Applicant: BEIJING VOYAGER TECHNOLOGY CO., LTD., Beijing (CN)

(72) Inventors: Jinyang LI, Beijing (CN); Fenglei WANG, Beijing (CN)

(73) Assignee: BEIJING VOYAGER TECHNOLOGY CO., LTD., Beijing (CN)

(21) Appl. No.: 17/074,798

(22) Filed: Oct. 20, 2020

Related U.S. Application Data
(63) Continuation of application No. PCT/CN2019/082113, filed on Apr. 10, 2019.

(51) Int. Cl. H04L 29/08; G06F 3/06

(52) U.S. Cl. CPC H04L 67/28; G06F 3/0604; G06F 3/067; G06F 3/0655; H04L 67/1097

(57) ABSTRACT

The present disclosure is related to systems and methods for storing data. The method includes: receiving a write request for writing a data set to a persistent data storage at a distributed proxy server from a data generation server; transmitting the data set to a target server group among a plurality of server groups by the distributed proxy server based on an identification number associated with the data set; storing the data set in a master server and a slave server of the target server group asynchronously by the target server group; reading the data set from the target server group by a consumer computing device coupled to the target server group; writing the data set to a database being operated by the persistent data storage by the consumer computing device.

### CROSS-REFERENCE TO RELATED APPLICATIONS

This application is a continuation of International Patent Application No. PCT/CN2019/082113, filed on Apr. 10, 2019, the entire contents of which are hereby incorporated by reference.

### TECHNICAL FIELD

This disclosure generally relates to information technology, and more particularly, relates to systems and methods for data storage.

### BACKGROUND

Data storage technologies are widely used in various fields. For example, in a system for the testing of autonomous driving, an autonomous vehicle (e.g., an unmanned robot) can generate a large amount of data (e.g., bag files) every day. It would be crucial, therefore, to store such data not only for security purposes but also that researchers can access and analyze the data timely and efficiently. In some cases, a data storage system can store the data generated by autonomous driving testing to a database (e.g., a Hadoop database (Hbase)). A user (e.g., an engineer) may retrieve and/or download the data from the database for further analysis. In-depth exploration of autonomous driving relies on fast and secure storage of the data. Therefore, it is desirable to provide methods and systems for storing data securely, efficiently, and concurrently.

### SUMMARY

According to one aspect of the present disclosure, a method for storing data is provided. The method may include: receiving, at a distributed proxy server from a data generation server, a write request for writing a data set to a persistent data storage; transmitting, by the distributed proxy server, the data set to a target server group among a plurality of server groups, based on an identification number associated with the data set, each server group of the plurality of server groups including a master server and a slave server; storing, by the target server group, the data set in the master server and the slave server asynchronously; reading, by a consumer computing device coupled to the target server group, the data set from the target server group; and/or writing, by the consumer computing device, the data set to a database being operated by the persistent data storage.

In some embodiments, the transmitting, by the distributed proxy server, the data set to a target server group may include: upon a determination that the master server of the target server group is operating properly, transmitting, by the distributed proxy server, the data set to the master server of the target server group.

In some embodiments, the storing, by the target server group, the data set in the master server and the slave server asynchronously may include: upon a determination that the slave server of the target server group is operating properly, storing, by the master server of the target server group, the data set in the master server of the target server group; and synchronizing, by the master server of the target server group, the data set to the slave server of the target server group.

In some embodiments, the data set may be read by the consumer computing device from the slave server of the target server group.

In some embodiments, the storing, by the target server group, the data set in the master server and the slave server asynchronously may include: upon a determination that the slave server of the target server group has failed, storing, by the master server of the target server group, the data set in the master server of the target server group.

In some embodiments, the data set may be read by the consumer computing device from the master server of the target server group.

In some embodiments, the method may further include: initiating a new server to couple with the master server of the target server group, and using the new server as a slave server of the target server group.

In some embodiments, the transmitting, by the distributed proxy server, the data set to a target server group may include: upon a determination that the slave server of the target server group is operating properly and the master server of the target server group has failed, transmitting, by the distributed proxy server, the data set to the slave server of the target server group.

In some embodiments, the method may further include: initiating a new server to couple with the slave server of the target server group, and using the new server as a master server of the target server group.

In some embodiments, the data set may be stored by the slave server of the target server group in the slave server of the target server group.

In some embodiments, the data set may be read by the consumer computing device from the slave server of the target server group.

In some embodiments, the method may further include: monitoring an operating state of the master server of the target server group, the slave server of the target server group, or the consumer computing device based on one or more corresponding log files generated by the master server of the target server group, the slave server of the target server group, or the consumer computing device.

In some embodiments, the method may further include: determining whether a data backlog is present in the target server group based on the monitoring result; and in response to a determination that a data backlog is present in the target server group, adjusting a data reading or writing speed of the consumer computing device based on a data writing status, or initiating another consumer computing device to share a workload of the consumer computing device.

In some embodiments, the method may further include: receiving, from the database, a data writing status; and adjusting a data reading or writing speed of the consumer computing device based on the data writing status.

In some embodiments, the database may be a Hadoop database (Hbase).

According to another aspect of the present disclosure, a method for storing data is provided. The method may include: receiving, at a distributed proxy server from a data generation server, a plurality of write requests for writing a plurality of data sets to a persistent data storage, each data set having a corresponding identification number; determining, by the distributed proxy server, a target server group among a plurality of server groups for each data set based on the identification number of the data set and operating states of the plurality of server groups; transmitting, by the distributed proxy server, each data set to a corresponding target server group, such that data sets having the same identification number are transmitted to a same target server group; storing, each data set in a corresponding target server group; reading, by a plurality of consumer computing devices, data stored in the plurality of server groups, each consumer computing device being coupled to one of the plurality of server groups, the each consumer computing device being configured to read a portion of the data from a coupled server group, the data including part or all of the plurality of data sets; and writing, by the plurality of consumer computing devices, the data to a database being operated by the persistent data storage.

In some embodiments, the method may further include: in response to a determination that the identification number of a first data set of the plurality of data sets is not identical to the identification numbers of the current data stored in the plurality of server groups, or the plurality of server groups are not available, initiating a new server group to store the first data set.

In some embodiments, the plurality of write requests may be concurrent write requests.

In some embodiments, the database may be a Hadoop database (Hbase).

In some embodiments, each server group of the plurality of server groups may include a master server and a slave server.

In some embodiments, each data set may be stored in a master server and a slave server of a corresponding target server group asynchronously.

In some embodiments, the transmitting, by the distributed proxy server, each data set to a corresponding target server group may include: upon a determination that the master server of the target server group is operating properly, transmitting, by the distributed proxy server, the data set to the master server of the target server group.

In some embodiments, the storing each data set in a corresponding target server group may include: upon a determination that the slave server of the target server group is operating properly, storing, by the master server of the target server group, the data set in the master server of the target server group; and synchronizing, by the master server of the target server group, the data set to the slave server of the target server group.

In some embodiments, the data set may be read by the consumer computing device from the slave server of the target server group.

In some embodiments, the storing each data set in a corresponding target server group may include: upon a determination that the slave server of the target server group has failed, storing, by the master server of the target server group, the data set in the master server of the target server group.

In some embodiments, the data set may be read by the consumer computing device from the master server of the target server group.

In some embodiments, the method may further include: initiating a new server to couple with the master server of the target server group, and using the new server as a slave server of the target server group.

In some embodiments, the transmitting, by the distributed proxy server, each data set to a corresponding target server group may include: upon a determination that the slave server of the target server group is operating properly and the master server of the target server group has failed, transmitting, by the distributed proxy server, the data set to the slave server of the target server group.

In some embodiments, the method may further include: initiating a new server to couple with the slave server of the target server group, and using the new server as a master server of the target server group.

In some embodiments, the data set may be stored by the slave server of the target server group in the slave server of the target server group.

In some embodiments, the data set may be read by the consumer computing device from the slave server of the target server group.

In some embodiments, the method of may further include: monitoring an operating state of the master server of the target server group, the slave server of the target server group, or the consumer computing device based on one or more corresponding log files generated by the master server of the target server group, the slave server of the target server group, or the consumer computing device.

In some embodiments, the method may further include: determining whether a data backlog is present in the target server group based on the monitoring result; and in response to a determination that a data backlog is present in the target server group, adjusting a data reading or writing speed of the consumer computing device based on a data writing status, or initiating another consumer computing device to share a workload of the consumer computing device.

In some embodiments, the method may further include: receiving, from the database, a data writing status; and adjusting a data reading or writing speed of at least one of the plurality of consumer computing devices based on the data writing status.

According to another aspect of the present disclosure, a system for storing data is provided. The system may include one or more distributed proxy servers, a plurality of server groups, and one or more persistent data storages. One of the one or more distributed proxy servers may be configured to: receive, from a data generation server, a write request for writing a data set to a persistent data storage; and transmit the data set to a target server group among the plurality of server groups, based on an identification number associated with the data set, each server group of the plurality of server groups including a master server and a slave server. The target server group of the plurality of server groups may be configured to store the data set in the master server and the slave server asynchronously. The data set may be read by a consumer computing device coupled to the target server group and written by the consumer computing device to a database being operated by the one or more persistent data storages.

According to another aspect of the present disclosure, a system for storing data is provided. The system may include one or more distributed proxy servers, a plurality of server groups, and one or more persistent data storages. One of the one or more distributed proxy servers may be configured to: receive, from a data generation server, a plurality of write requests for writing a plurality of data sets to the one or more persistent data storages; and transmit each data set to a corresponding target server group among the plurality of server groups, based on an identification number associated with the data set, such that data sets having the same identification number are transmitted to a same target server group. The target server group of the plurality of server groups may be configured to store the data set. Data stored in the plurality of server groups may be read by a plurality of consumer computing devices, and written by the plurality of consumer computing devices to a database being operated by the one or more persistent data storages. Each consumer computing device may be coupled to one of the plurality of server groups. The data may include part or all of the plurality of data sets.

According to another aspect of the present disclosure, a non-transitory computer readable medium may be provided. The non-transitory computer readable medium may include at least one set of instructions for storing data. When executed by one or more processors of a computing device, the at least one set of instructions may cause the computing device to perform a method including: receiving, at a distributed proxy server from a data generation server, a write request for writing a data set to a persistent data storage; causing the distributed proxy server to transmit the data set to a target server group among a plurality of server groups, based on an identification number associated with the data set, each server group of the plurality of server groups including a master server and a slave server; storing the data set in the master server and the slave server asynchronously; causing a consumer computing device coupled to the target server group to read the data set from the target server group; and causing the consumer computing device to write the data set to a database being operated by the persistent data storage.

According to another aspect of the present disclosure, a non-transitory computer readable medium may be provided. The non-transitory computer readable medium may include at least one set of instructions for storing data. When executed by one or more processors of a computing device, the at least one set of instructions may cause the computing device to perform a method including: receiving, at a distributed proxy server from a data generation server, a plurality of write requests for writing a plurality of data sets to a persistent data storage, each data set having a corresponding identification number; determining a target server group among a plurality of server groups for each data set based on the identification number of the data set and operating states of the plurality of server groups; transmitting each data set to a corresponding target server group, such that data sets having the same identification number are transmitted to a same target server group; storing, each data set in a corresponding target server group; causing a plurality of consumer computing devices to read data stored in the plurality of server groups, each consumer computing device being coupled to one of the plurality of server groups, the each consumer computing device being configured to read a portion of the data from a coupled server group, the data including part or all of the plurality of data sets; and causing the plurality of consumer computing devices to write the data to a database being operated by the persistent data storage.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. The drawings are not to scale. These embodiments are non-limiting exemplary embodiments, in which like reference numerals represent similar structures throughout the several views of the drawings, and wherein:

FIG. 1 is a schematic diagram illustrating an exemplary data storage system according to some embodiments of the present disclosure;

FIG. 2 is a schematic diagram illustrating exemplary hardware and/or software components of an exemplary computing device according to some embodiments of the present disclosure;

FIG. 3 is a schematic diagram illustrating exemplary hardware and/or software components of an exemplary mobile device on which a terminal device may be implemented according to some embodiments of the present disclosure;

FIG. 4 is a block diagram illustrating an exemplary processing device according to some embodiments of the present disclosure;

FIG. 5 is a flowchart illustrating an exemplary process for storing data into a database according to some embodiments of the present disclosure;

FIGS. 6A and 6B are flowcharts illustrating an exemplary process for storing data sets in a master server and a slave server asynchronously according to some embodiments of the present disclosure;

FIG. 7 is a flowchart illustrating an exemplary process for storing data sets into a database according to some embodiments of the present disclosure;

FIG. 8 is a flowchart illustrating an exemplary process for monitoring data storage according to some embodiments of the present disclosure; and

FIG. 9 is a schematic diagram illustrating an exemplary system for data storage according to some embodiments of the present disclosure.

### DETAILED DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this disclosure, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operations and functions of the related elements of structure and the combination of parts and economies of manufacture, may become more apparent upon consideration of the following description with reference to the accompanying drawings, all of which form part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments of the present disclosure. It is to be expressly understood, the operations of the flowcharts may be implemented not in order. Conversely, the operations may be implemented in inverted order, or simultaneously. Moreover, one or more other operations may be added to the flowcharts. One or more operations may be removed from the flowcharts.

Moreover, the systems and methods in the present disclosure may be applied to any application scenario in which a data storage is required. For example, the system or method of the present disclosure may be applied to a transportation system, a shopping system, a retrieval system, an autonomous system, or the like, or any combination thereof. Specifically, the transportation system may include land, ocean, aerospace, or the like, or any combination thereof. The transportation systems may provide transportation service for users using various vehicles. The vehicles of the transportation service may include a taxi, a private car, a hitch, a bus, a train, a bullet train, a high speed rail, a subway, a vessel, an aircraft, a spaceship, a hot-air balloon, an autonomous vehicle, a bicycle, a tricycle, a motorcycle, or the like, or any combination thereof. The system or method of the present disclosure may be applied to a taxi hailing service, a chauffeur service, a delivery service, a carpooling service, a bus service, a take-out service, a driver hiring service, a shuttle service, a travel service, or the like, or any combination thereof.

An aspect of the present disclosure is directed to systems and methods for storing data. According to the systems and methods of the present disclosure, a terminal device (e.g., an unmanned robot) may generate a plurality of data sets. A distributed proxy server may receive a write request for writing a data set to a persistent data storage. The distributed proxy server may transmit the data sets to a target server group among a plurality of server groups based on an identification number associated with the data set, each server group of the plurality of server groups including a master server and a slave server. The target server group may store the data set in the master server and the slave server asynchronously. A consumer computing device coupled to the target server group may read the data set from the target server group and write the data set to a database being operated by the persistent data storage. According to the systems and methods of the present disclosure, the data sets generated by the terminal device may be stored quickly and securely, which can improve the efficiency and security of data storage. Each of the data sets may have an identification number, which can ensure that the written data sets are kept in sequence. The systems and methods in the present disclosure can support a distributed deployment, in which proxy servers, store servers, and consumers can be added or deleted dynamically. The systems and methods can be used for high concurrent and/or asynchronous data writing and data persistence. Besides, a monitor can monitor operating states of the data sets to avoid or handle a data backlog.

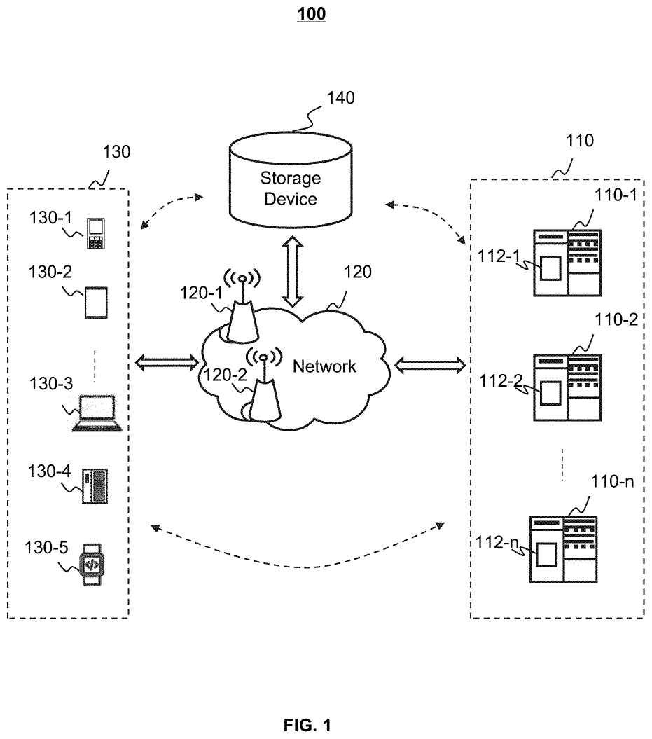

FIG. 1 is a schematic diagram illustrating an exemplary data storage system according to some embodiments of the present disclosure. The data storage system 100 may include one or more servers 110, a network 120, a storage device 140, and one or more terminal devices 130. In some embodiments, the data storage system 100 may be a distributed queue system. In some embodiments, the data storage system 100 may be configured for high concurrent writing of data and/or persistent storing of the data. The data storage system 100 may use a distributed queue including, for example, Zookeeper, kafka, RabbitMQ, Apache RocketMQ, Apache ActiveMQ, ZeroMQ, MetaMQ, Redis, MySQL, PhxSQL, NSQ, Disque, etc.

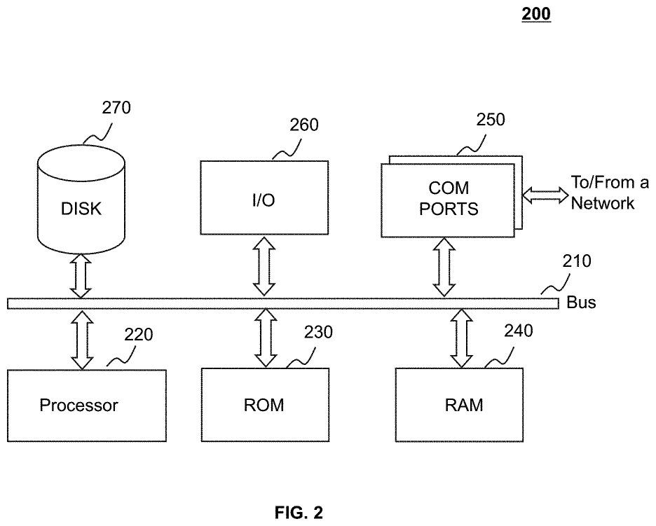

In some embodiments, the servers 110 may include one or more servers such as a server 110-1, a server 110-2, . . . , a server 110-n. The servers 110 may be configured to perform one or more functions for storing data, processing data, or the like, or any combination thereof, independently or jointly. In some embodiments, the servers 110 may be a single server or a server group. The server group may be centralized, or distributed. In some embodiments, the data storage system 100 may be a distributed system, and the distributed system may include one or more distributed proxy servers, a plurality of distributed store server groups, or the like, or a combination thereof. Each of the servers 110 may include any type of computerized device or system such as a personal computer, workstation, network system, or large mainframe system, data communication system, switch, router, data storage system, etc. In some embodiments, the servers 110 may be local or remote. For example, the servers 110 may access information and/or data stored in the terminal devices 130, and/or the storage device 140 via the network 120. As another example, the servers 110 may be directly connected to the terminal devices 130, and/or the storage device 140 to access stored information and/or data. In some embodiments, the servers 110 may receive and/or process information and/or data from the terminal devices 130 directly or via the network 120. In some embodiments, the servers 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the servers 110 may be implemented on a computing device 200 having one or more components illustrated in FIG. 2 in the present disclosure.

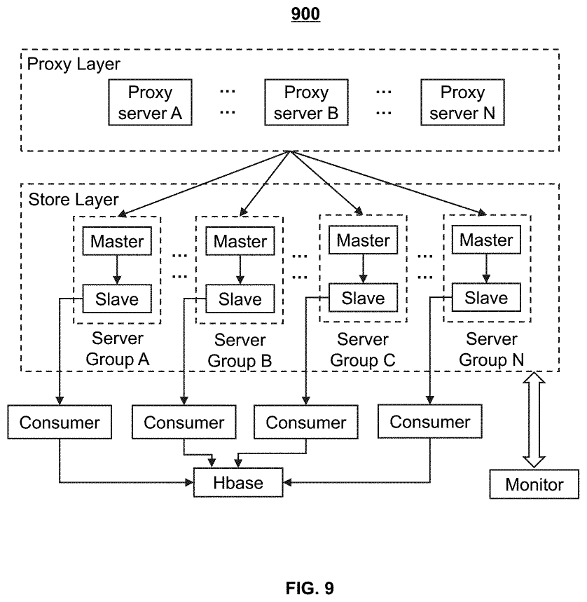

In some embodiments, the servers 110 may include one or more proxy servers (e.g., the proxy servers illustrated in FIG. 9), one or more store servers (e.g., the store servers illustrated in FIG. 9), one or more consumers (also referred to as consumer computing devices, e.g., the consumers illustrated in FIG. 9), one or more monitors (also referred to as monitoring computing devices, e.g., the monitor illustrated in FIG. 9), or the like, or any combination thereof. The proxy server(s) may be configured to receive request(s) from the terminal device(s) 130 and/or a data generation server, and/or transmit the information and/or data to the one or more store servers. In some embodiments, the proxy servers may be set as a proxy layer of the data storage system 100. The store server(s) may be configured to receive the information and/or data from the one or more proxy servers, and/or transmit the information and/or data to the one or more consumers. In some embodiments, the store servers may be set as a store layer of the data storage system 100. The consumer(s) may be configured to consume the information and/or data from the one or more store servers, and write the information and/or data to a storage (e.g., the storage device 140). The monitor(s) may be configured to monitor operating state(s) of the data storage system 100 (e.g., operating state(s) of the proxy servers, operating state(s) of the store servers, operating state(s) of the consumer, etc.). The proxy servers, the store servers, the consumers, and the monitors may be connected and/or communicated with each other directly (e.g., via one or more data cables) or via the network 120. In some embodiments, the proxy server(s), the store server(s), the consumer(s), and/or the monitor(s) may be integrated into a single server. In some embodiments, one of the servers 110 may perform at least a portion of the functions of the proxy servers, the store servers, the consumer(s), and/or the monitor(s). In some embodiments, the servers 110 may include or communicate with one or more data generation servers. The data generation server may be configured for model training and/or generate data associated with the model training.

In some embodiments, the servers 110 may include one or more processing devices 112 (e.g., single-core processing device(s) or multi-core processor(s)). As shown in FIG. 1, the server 110-1 may include a processing device 112-1, the server 110-2 may include a processing device 112-2, . . . , and the server 110-n may include a processing device 112-n. The processing devices 112 may process information and/or data to perform one or more functions described in the present disclosure. For example, the processing devices 112 may receive the data and/or information from the terminal devices 130, the storage device 140, or an external device, or any combination thereof. As another example, the processing devices 112 may receive one or more write requests for writing data sets to one or more persistent data storages. As a further example, the processing devices 112 may transmit the data and/or information to the terminal devices 130, the storage device 140, or other devices (e.g., a persistent data storage).

In some embodiments, the processing devices 112 may include one or more hardware processors, such as a central processing unit (CPU), an application-specific integrated circuit (ASIC), an application-specific instruction-set processor (ASIP), a graphics processing unit (GPU), a physics processing unit (PPU), a digital signal processor (DSP), a field-programmable gate array (FPGA), a programmable logic device (PLD), a controller, a microcontroller unit, a reduced instruction-set computer (RISC), a microprocessor, or the like, or any combination thereof.

The network 120 may facilitate the exchange of information and/or data. In some embodiments, one or more components in the data storage system 100 (e.g., the servers 110, the storage device 140, the terminal devices 130) may send information and/or data to other component(s) in the data storage system 100 via the network 120. For example, the processing devices 112 may receive a write request from a data generation server via the network 120. In some embodiments, the network 120 may be any type of wired or wireless network, or a combination thereof. Merely by way of example, the network 120 may include a cable network, a wireline network, an optical fiber network, a telecommunications network, an intranet, the Internet, a local area network (LAN), a wide area network (WAN), a wireless local area network (WLAN), a metropolitan area network (MAN), a wide area network (WAN), a public telephone switched network (PSTN), a Bluetooth™ network, a ZigBee network, a near field communication (NFC) network, or the like, or any combination thereof. In some embodiments, the network 120 may include one or more network access points. For example, the network 120 may include wired or wireless network access points such as base stations and/or internet exchange points 120-1, 120-2, . . . , through which one or more components of the data storage system 100 may be connected to the network 120 to exchange data and/or information.

In some embodiments, the terminal device(s) 130 may be configured to facilitate communications between a user (e.g., an engineer) and the data storage system 100. For example, the user may monitor a data store progress by logging in an application coupled with (or that can communicate with) the data storage system 100 via the terminal devices 130. In some embodiments, the application may provide a data access interface for one or more users of the data, so that the user(s) may manage the data store progress via the application. In some embodiments, the terminal device(s) 130 may include a mobile device 130-1, a tablet computer 130-2, a laptop computer 130-3, a built-in device in a vehicle 130-4, a wearable device 130-5, or the like, or any combination thereof. In some embodiments, the mobile device 130-1 may include a smart home device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the smart mobile device may include a smartphone, a personal digital assistance (PDA), a gaming device, a navigation device, a point of sale (POS) device, or the like, or any combination thereof. In some embodiments, the virtual reality device and/or the augmented reality device may include a virtual reality helmet, virtual reality glasses, a virtual reality patch, an augmented reality helmet, augmented reality glasses, an augmented reality patch, or the like, or any combination thereof. For example, the virtual reality device and/or the augmented reality device may include Google™ Glasses, an Oculus Rift™, a HoloLens™, a Gear VR™, etc. In some embodiments, the built-in device in the vehicle 130-4 may include an onboard computer, an onboard television, etc. In some embodiments, the wearable device 130-5 may include a smart bracelet, a smart footgear, smart glasses, a smart helmet, a smart watch, smart clothing, a smart backpack, a smart accessory, or the like, or any combination thereof. In some embodiments, the server 110 may be integrated into the terminal device(s) 130.

The storage device 140 may store data and/or instructions. In some embodiments, the storage device 140 may store data obtained from the terminal devices 130, one or more data generation servers, and/or the processing devices 112. For example, the storage device 140 may store a plurality of write requests received from one or more data generation servers, and/or one or more terminal devices 130. As another example, the storage device 140 may store the data and/or information processed by the processing devices 112. As a further example, the storage device 140 may store data received from the data generation servers. In some embodiments, the storage device 140 may store data and/or instructions that the server 110 may execute or use to perform exemplary methods described in the present disclosure. For example, the storage device 140 may store instructions that the processing devices 112 may execute or use to transmit the data set to a target server group based on characteristics of the information and/or data. As another example, the storage device 140 may store instructions that the processing devices 112 may execute or use to store the data. As still another example, the storage device 140 may store instructions that the processing devices 112 may execute or use to cause the consumer to write the data and/or information to a storage device (e.g., a database operated by a persistent data storage).

In some embodiments, the storage device 140 may include a mass storage, a removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyrisor RAM (T-RAM), and a zero-capacitor RAM (Z-RAM), etc. Exemplary ROM may include a mask ROM (MROM), a programmable ROM (PROM), an erasable programmable ROM (EPROM), an electrically-erasable programmable ROM (EEPROM), a compact disk ROM (CD-ROM), and a digital versatile disk ROM, etc. In some embodiments, the storage device 140 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage device 140 may be connected to the network 120 to communicate with one or more components in the data storage system 100 (e.g., the servers 110, the terminal devices 130, etc.). One or more components in the data storage system 100 may access the data or instructions stored in the storage device 140 via the network 120. In some embodiments, the storage device 140 may be directly connected to or communicate with one or more components in the data storage system 100 (e.g., the servers 110, the terminal devices 130, etc.). In some embodiments, at least a portion of the storage device 140 may be part of the servers 110.

It should be noted that the data storage system 100 is merely provided for the purposes of illustration, and is not intended to limit the scope of the present disclosure. For persons having ordinary skills in the art, multiple variations or modifications may be made under the teachings of the present disclosure. However, those variations and modifications do not depart from the scope of the present disclosure. For example, the data storage system 100 may further include a database operated by the storage device 140, an information source, or the like. As another example, the data storage system 100 may be implemented on other devices to realize similar or different functions. As a further example, the storage device 140 may include one or more persistent data storages.

FIG. 2 is a schematic diagram illustrating exemplary hardware and/or software components of an exemplary computing device according to some embodiments of the present disclosure. In some embodiments, at least one of the servers 110 may be implemented on the computing device 200. For example, the processing device 112 may be implemented on the computing device 200 and configured to perform functions of the processing device 112 disclosed in this disclosure.

The computing device 200 may be used to implement any component of the data storage system 100 of the present disclosure. For example, the processing device 112 of the data storage system 100 may be implemented on the computing device 200, via its hardware, software program, firmware, or a combination thereof. Although only one such computer is shown for convenience, the computer functions related to the data storage system 100 as described herein may be implemented in a distributed manner on a number of similar platforms to distribute the processing load.

The computing device 200, for example, may include communication (COM) ports 250 connected to and from a network (e.g., the network 120) connected thereto to facilitate data communications. The computing device 200 may also include a processor (e.g., a processor 220), in the form of one or more processors (e.g., logic circuits), for executing program instructions. For example, the processor may include interface circuits and processing circuits therein. The interface circuits may be configured to receive electronic signals from a bus 210, wherein the electronic signals encode structured data and/or instructions for the processing circuits to process. The processing circuits may conduct logic calculations, and then determine a conclusion, a result, and/or an instruction encoded as electronic signals. Then the interface circuits may send out the electronic signals from the processing circuits via the bus 210.

The computing device 200 may further include program storage and data storage of different forms, for example, a disk 270, and a read only memory (ROM) 230, or a random access memory (RAM) 240, for storing various data files to be processed and/or transmitted by the computing device 200. The computing device 200 may also include program instructions stored in the ROM 230, the RAM 240, and/or other type of non-transitory storage medium to be executed by the processor 220. The methods and/or processes of the present disclosure may be implemented as the program instructions. The computing device 200 may also include an I/O component 260, supporting input/output between the computing device 200 and other components therein. The computing device 200 may also receive programming and data via network communications.

Merely for illustration, only one processor is described in the computing device 200. However, it should be noted that the computing device 200 in the present disclosure may also include multiple processors, and thus operations that are performed by one processor as described in the present disclosure may also be jointly or separately performed by the multiple processors. For example, the processor of the computing device 200 executes both operation A and operation B. As another example, operation A and operation B may also be performed by two different processors jointly or separately in the computing device 200 (e.g., the first processor executes operation A and the second processor executes operation B, or the first and second processors jointly execute operations A and B).

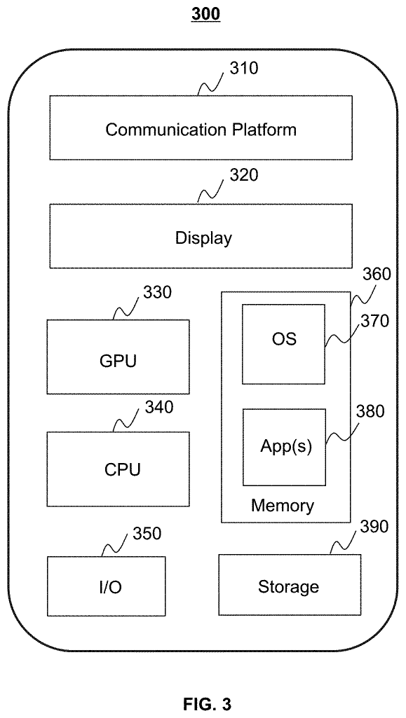

FIG. 3 is a schematic diagram illustrating exemplary hardware and/or software components of an exemplary mobile device on which a terminal device may be implemented according to some embodiments of the present disclosure. As illustrated in FIG. 3, the mobile device 300 may include a communication platform 310, a display 320, a graphic processing unit (GPU) 330, a central processing unit (CPU) 340, an I/O 350, a memory 360, and storage 390. In some embodiments, any other suitable component, including but not limited to a system bus or a controller (not shown), may also be included in the mobile device 300. In some embodiments, a mobile operating system 370 (e.g., iOS™, Android™, Windows Phone™) and one or more applications 380 may be loaded into the memory 360 from the storage 390 in order to be executed by the CPU 340. The applications 380 may include a browser or any other suitable mobile apps for receiving and rendering information relating to positioning or other information from the processing device 112. User interactions with the information stream may be achieved via the I/O 350 and provided to the processing device 112 and/or other components of the data storage system 100 via the network 120.

To implement various modules, units, and their functionalities described in the present disclosure, computer hardware platforms may be used as the hardware platform(s) for one or more of the elements described herein. A computer with user interface elements may be used to implement a personal computer (PC) or any other type of work station or terminal device. A computer may also act as a server if appropriately programmed.

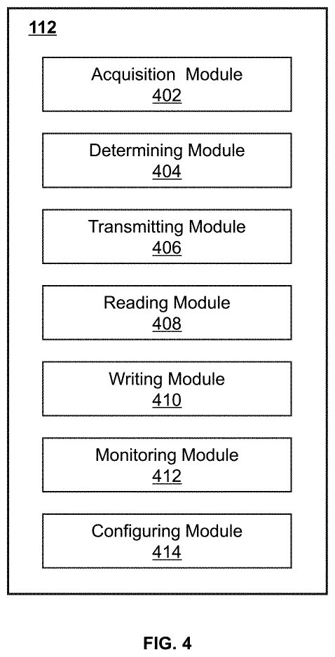

FIG. 4 is a block diagram illustrating an exemplary processing device according to some embodiments of the present disclosure. The processing device 112 may include an acquisition module 402, a determining module 404, a transmitting module 406, a reading module 408, a writing module 410, a monitoring module 412 and a configuring module 414.

The acquisition module 402 may be configured to receive one or more write requests for writing one or more data sets to one or more persistent data storages. For example, the acquisition module 402 may receive one or more write requests from the terminal devices 130 via the network 120. As another example, the acquisition module 402 may receive the one or more write requests from one or more data generating servers. In some embodiments, the write request(s) may include or be associated with characteristics of the data set(s).

In some embodiments, the determining module 404 may be configured to determine the operating states of the servers 110. For example, the determining module 404 may determine whether a master server of a target server group is operating properly. As another example, the determining module 404 may determine whether a slave server of the target server group is operating properly. As still another example, the determining module 404 may determine another (e.g., idle) server group or initiating a new server group for storing the data set(s). As still another example, the determining module 404 may determine whether a data backlog is present in the server group(s). In some embodiments, the determining module 404 may determine a target server group among a plurality of server groups for each data set based on the characteristics of the data set(s) and/or operating states of the plurality of server groups.

The transmitting module 406 may be configure to transmit each of the data sets to a target server group among a plurality of server groups. For example, the transmitting module 406 may transmit the data set to the master server of the target server group. As another example, the transmitting module 406 may transmit the data set to the slave server of the target server group.

The reading module 408 may be configured to read data set(s) from the servers 110. For example, the reading module 408 may read the data set(s) from the plurality of server groups. As another example, the reading module 408 may read the data set(s) from the master server of the target server group. As still another example, the reading module 408 may read the data set(s) from the slave server of the target server group.

The writing module 410 may be configured to write the data set(s) to a storage device. For example, the writing module 410 may write the data set(s) to a database being operated by the persistent data storage. As another example, the writing module 410 may store the data set(s) in a corresponding target server group. As a further another example, the writing module 410 may store the data set(s) in the master server of the target server group. As still another example, the writing module 410 may store the data set(s) in the slave server of the target server group. As still another example, the writing module 410 may synchronize the data set(s) of the master server of the target server group to the slave server of the target server group. As still another example, the writing module 410 may store the data set(s) in the master server and the slave server asynchronously.

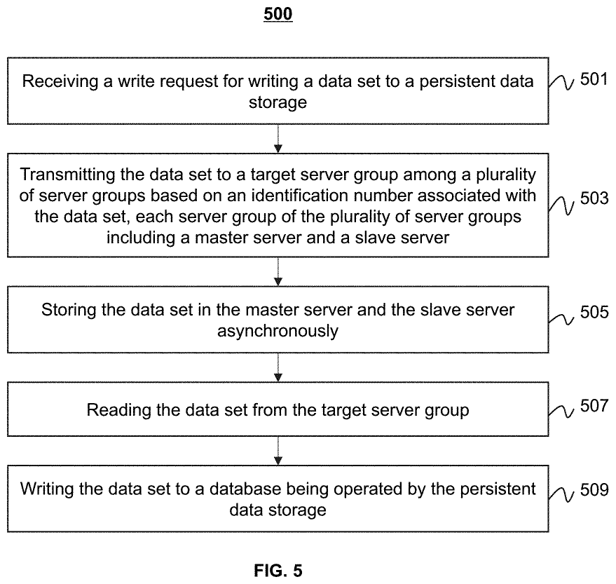

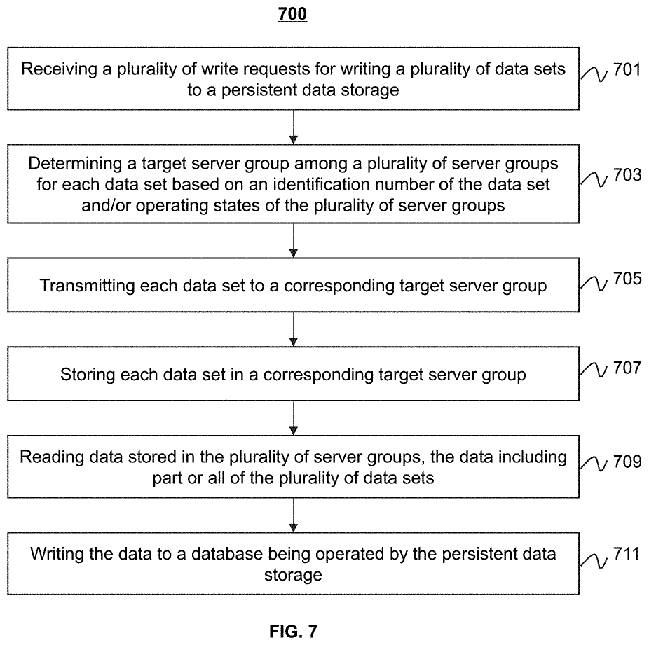

The monitoring module 412 may be configured to monitor operating state(s) of the master server(s) of the server group(s) (e.g., the target server group illustrated in FIGS. 5-7, the plurality of server groups illustrated in FIG. 7), the slave server(s) of the server group(s), the proxy servers, and/or the consumer computing device(s).

The configuring module 414 may be configured to configure the servers 110. For example, the configuring module 414 may initiate a new server to couple with the master server of the target server group, and use the new server as a slave server of the target server group. As another example, the configuring module 414 may initiate a new server to couple with the slave server of the target server group, and use the new server as a master server of the target server group. As still another example, the configuring module 414 may adjust data reading and/or writing speed(s) of the consumer computing device(s) and/or initiate another consumer computing device to share a workload of the consumer computing device(s). As a further example, the configuring module 414 may initiate a new (e.g., idle) server group for storing the data set(s) transmitted from the proxy servers.

It should be noted that the above description of the processing device 112 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, the processing device 112 may further include a storage module (not shown) used to store the data sets and the data generated during the operation of the processing device 112 (e.g., monitoring results of the monitoring module 412, configuration data of the configuring module 414, etc.). As another example, the determining module 404 and the configuring module 414 may be combined as a single module that can both determine the operating states of the servers and configure the servers.

FIG. 5 is a flowchart illustrating an exemplary process for storing data into a database according to some embodiments of the present disclosure. The process 500 may be executed by the data storage system 100. For example, the process 500 may be implemented as a set of instructions stored in the storage ROM 230 or RAM 240. The processor 220 and/or the modules in FIG. 4 may execute the set of instructions, and when executing the instructions, the processor 220 and/or the modules may be configured to perform the process 500. The operations of the illustrated process presented below are intended to be illustrative. In some embodiments, the process 500 may be accomplished with one or more additional operations not described and/or without one or more of the operations discussed. Additionally, the order in which the operations of the process 500 illustrated in FIG. 5 and described below is not intended to be limiting.

In 501, the processing devices 112 (e.g., the acquisition module 402) of the proxy server(s) may receive one or more write requests for writing one or more data sets to one or more persistent data storages.

In some embodiments, the write request(s) may be received from one or more data generation servers. In some embodiments, the data generation servers may generate or obtain the data set(s) and/or generate the corresponding write request(s). In some embodiments, the data generation server(s) may generate the data set(s) by performing one or more processing operations on a plurality of initial data sets. In some embodiments, the initial data set(s) may include data associated with online to offline (O2O) services, for example, data related to orders, data related to vehicles, data related to vehicle transporting routes, payment data, traffic data, location data, data related to travel time, data related to passengers' preference, data related to drivers' preference, data related to departure location, destination data, or the like, or any combination thereof. Merely for illustration purposes, the O2O service may include a taxi service, a carpooling service, a hitch service, a delivery service, an online shopping service, a medical service, a map-based service, or the like, or any combination thereof. In some embodiments, the initial data set(s) may include data associated with autonomous driving or autonomous driving tests, for example, road condition information, map information, a state of the unmanned robots during driving (e.g., a location of the unmanned robots, a velocity of the unmanned robots, an acceleration of the unmanned robots, a driving path of the unmanned robots), or the like, or any combination thereof. In some embodiments, the processing operations may include compressing the initial data, verifying the initial data, filtering the initial data, segmenting the initial data, or the like, or any combination thereof. In some embodiments, the processing operations may include machine learning model training. The data set(s) to be written to the persistent data storage(s) may include the processed data (e.g., compressed data, verified data, filtered data, segmented data, data generated by machine learning model training, etc.).

In some embodiments, the write request(s) may include or be associated with characteristics of the data set(s), for example, types, sources, uses, names, storage paths, sizes, or the like, or any combination thereof. In some embodiments, the write request(s) may include a description of the contents that are requested to be written. In some embodiments, the description of the contents may indicate which type of data is requested, a size of the requested data, mean(s) of creation of the requested data, a time and/or date of creation, a creator or author of the requested data, a location on a computer network where the requested data was created, a data quality of the requested data, or the like, or a combination thereof. Taking machine learning model training as an example, the write request(s) may indicate a training time, a name of a training model that generates the data, a type or purpose of model training tasks, a description of the contents generated by the training, or the like, or any combination thereof. In some embodiments, the write request(s) may be recorded in a log file, for example, a log file of the proxy servers. In some embodiments, the proxy server(s) may generate an identification number for each of the data sets using one or more algorithms (e.g., a hash algorithm). In some embodiments, the identification number(s) may be generated based on characteristics of the data set(s) or the description(s) of the contents that are requested to be written. In some embodiments, data sets generated by a same type of model training tasks, generated by a same training model, or generated based on the same initial data may have the same identification number.

In 503, the processing devices 112 (e.g., the transmitting module 406) of the proxy servers may transmit each of the data sets to a target server group among a plurality of server groups based on an identification number associated with the data set. In some embodiments, a server group may include a master server and/or a slave server.

In some embodiments, the store servers may be configured as a plurality of server groups. In some embodiments, each server group of the plurality of server groups may include a master server and/or a slave server. In some embodiments, the data sets having the same identification number may be transmitted to the same server group, which can retain the sequence of a data stream of a plurality of data sets. In some embodiments, the proxy servers may identify the target server group (among the plurality of server groups) that has current data with the same identification number as the data set to be written. In some embodiments, if the identification number of the data set to be written is not identical to any one of the identification numbers of the current data stored in the plurality of server groups, or the plurality of server groups are not available, the proxy servers may initiate a new server group (e.g., among the servers 110) to store the data set.

In some embodiments, the master server and the slave server may communicate with each other directly (e.g., a data cable) or via the network 120. In some embodiments, the master server and the salve server may store the same data. For example, the master server may transmit data stored therein to the slave server. As another example, the slave server may transmit data stored therein to the master server. The configuration of the server group including the master server and the slave server can improve the stability of the data storage system 100, ensure data security, and reduce risk of data loss due to downtime. In some embodiments, the master server and/or the slave server may generate log files that record operating states of the master server and/or the slave server, respectively.

In 505, the processing devices 112 (e.g., the writing module 410) of the store servers may store the data set in the master server and the slave server asynchronously.

In some embodiments, the store servers may store the data set respectively in the master server and the slave alternately, or in sequence. In some embodiments, the master server may store the data set after receiving the data set from the proxy servers. In some embodiments, the master server may transmit the data set to the slave server, and the slave server may store the data set. For example, the master server may receive the data set from the proxy servers and store the data set in the master server; the master server may send a write request for writing the data set to the slave server; if the slave server is operating properly, the slave server may respond to the master server; the master server may transmit the data set to the slave server; and the slave server may write the date set into the slave server. If the master is not operating properly, the slave server may receive the data set from the proxy servers and store the data set in the slave server. The storing process of the data set in the master server and the slave server may be asynchronous, which can improve a concurrent writing capacity and the stability of the data storage system 100.

In 507, the processing devices 112 (e.g., the reading module 408) of the consumer computing device(s) coupled to the target server group may read the data set from the target server group.

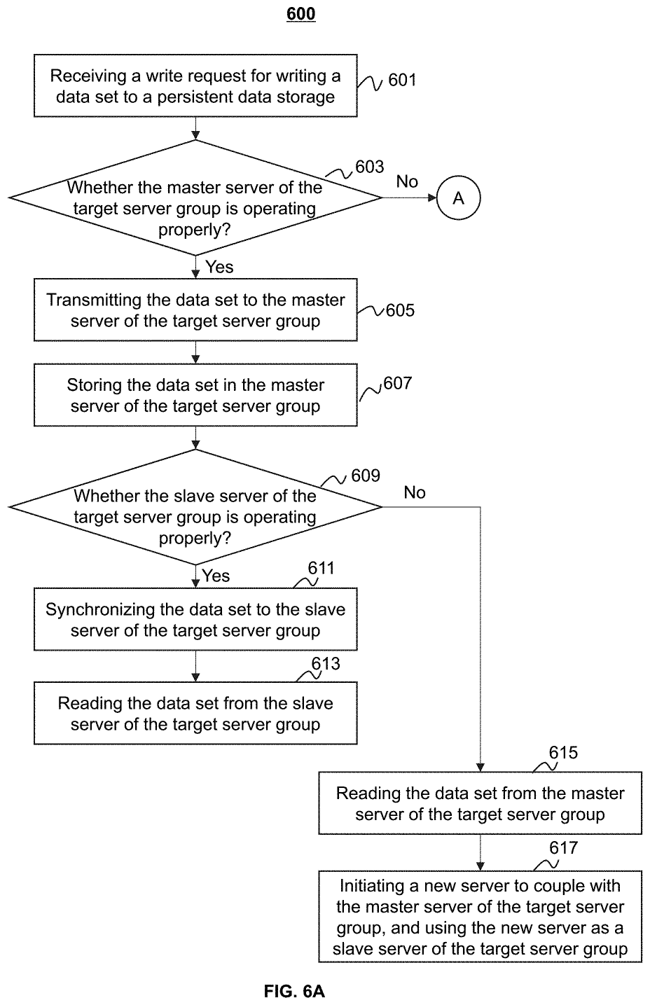

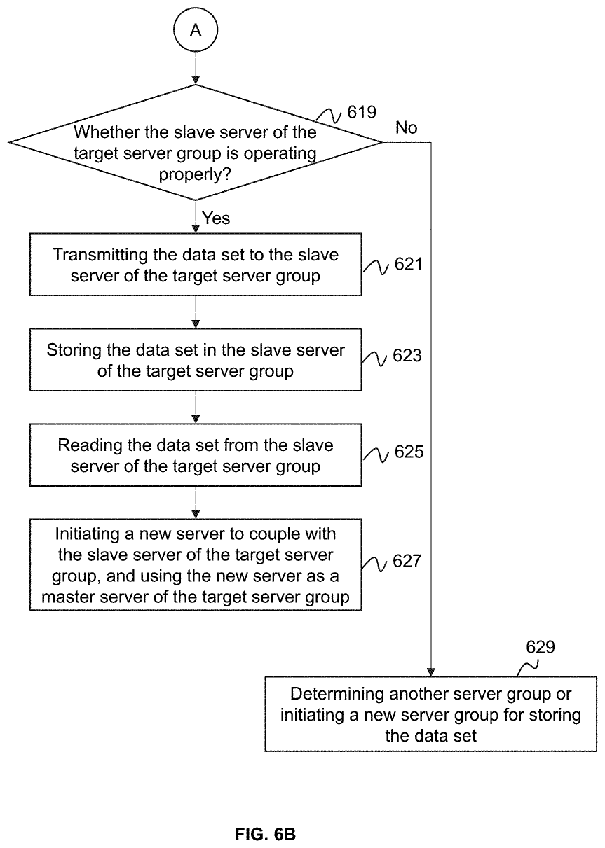

The consumer computing device(s) may consume or read data stored in the server group(s). The data may include a part or all of the plurality of data sets, and/or data that is already stored in the server group(s). In some embodiments, each consumer computing device may be coupled to one of the plurality of server groups. In some embodiments, the consumer computing device may communicate with and/or be connected to the master server and/or the slave server of the target server group to read the data set. In some embodiments, the consumer computing device may record information of operation of the consumer computing device in the log file of the consumer computing device. More descriptions of the data communications between the proxy servers, the store servers, and the consumers may be found elsewhere in the present disclosure (e.g., FIGS. 6A and 6B, and the description thereof).

In 509, the processing devices 112 (e.g., the writing module 410) of the consumer computing device(s) may write the data set to a database being operated by the persistent data storage. The database may include Hadoop Database (HBase), Cassandra, Oracle, Sybase, IBM INFORMIX, INGRES database, Microsoft SQL Server, or the like. In some embodiments, the database may be operated by the persistent data storage. In some embodiments, the persistent storage may include but not limit to a ROM, a flash memory, a floppy disk, a magnetic disk, an optical disk, a hard disk drive, a solid-state drive, or the like, or any combination thereof. In some embodiments, the persistent data storage may be set in an Internet Data Center (IDC). As used herein, a data center may refer to a dedicated space configured to house computer systems and associated components, such as telecommunication equipment and storage devices (e.g., the storage device 140). The IDC may refer to a data center established by a service provider or IDC company to provide stable and wide-band network services, high performance computing services, and/or hosting services.

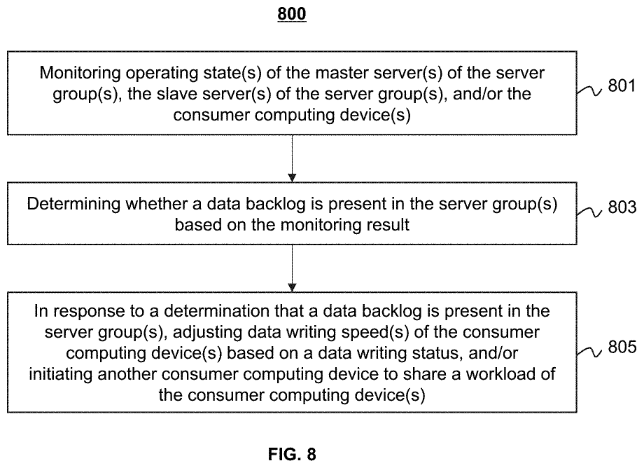

It should be noted that the above description is merely provided for the purpose of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, one or more operations illustrated in FIG. 8 may be added in process 500. In some embodiments, the proxy servers may receive one or more write requests from the terminal device(s) 130. For example, a user (e.g., an engineer) may initiate write request(s) through an application installed on the terminal device (s) 130, and the terminal device(s) 130 may transmit the write request(s) to the proxy servers.

FIGS. 6A and 6B are flowcharts illustrating an exemplary process for storing data sets in a master server and a slave server asynchronously according to some embodiments of the present disclosure. In some embodiments, the process 600 may be implemented in the data storage system 100. The process 600 may be executed by the data storage system 100. For example, the process 600 may be implemented as a set of instructions stored in the storage ROM 230 or RAM 240. The processor 220 and/or the modules in FIG. 4 may execute the set of instructions, and when executing the instructions, the processor 220 and/or the modules may be configured to perform the process 600. The operations of the illustrated process presented below are intended to be illustrative. In some embodiments, the process 600 may be accomplished with one or more additional operations not described and/or without one or more of the operations discussed. Additionally, the order in which the operations of the process 600 illustrated in FIGS. 6A and 6B and described below is not intended to be limiting. In some embodiments, operations 503 through 507 illustrated in FIG. 5 may be performed according to the process 600 illustrated in FIG. 6.

In 601, the processing devices 112 (e.g., the acquisition module 402) of the proxy servers may receive a write request for writing data set(s) to a persistent data storage. More descriptions of the write request may be found elsewhere in the present disclosure (e.g., operation 501 in FIG. 5 and the description thereof).

In 603, the processing devices 112, (e.g., the determining module 404) of the proxy servers may determine whether the master server of the target server group is operating properly. In some embodiments, the proxy servers may identify the target server group (among the plurality of server groups) that has current data with the same identification number as the data set to be written. In some embodiments, the proxy servers may determine the operating state of the master server based on whether an external device connected thereto is operating properly. For example, if the external device is operating improperly, the proxy servers may determine that the master server is operating improperly. In some embodiments, the proxy servers may determine the operating state of the master server based on a data flow rate of the master server. For example, if the data flow rate of the master server is zero in a time period, the proxy servers may determine that the master server is operating improperly. In some embodiments, the proxy servers may determine the operating state of the master server based on a log file of the master server. In response to a determination that the master server of the target server group is operating properly, the process 600 may proceed to operation 605. In response to a determination that the master server of the target server group is operating improperly, the process 600 may proceed to operation 619 in FIG. 6B.

In 605, the processing devices 112 (e.g., the transmitting module 406) of the proxy servers may transmit the data set to the master server of the target server group. More description of the transmission of the data set to the master server may be found elsewhere in the present disclosure (operation 503 in FIG. 5 and the description thereof).

In 607, the processing devices 112 (e.g., the writing module 410) of the store servers may store the data set in the master server of the target server group. In some embodiments, the master server may receive the data set from the proxy servers and store the data set.

In 609, the processing devices 112 (e.g., the determining module 404) of the store servers may determine whether the slave server of the target server group is operating properly. In some embodiments, the processing devices 112 may determine an operating state of the slave server. The determination of the operating state of the slave server may be similar to the determination of the operating state of the master server, and more descriptions may refer to operation 603 and the description thereof. In response to a determination that the slave server is operating properly, process 600 may proceed to operation 611. In response to a determination that the slave server of the target server group is operating improperly, the process 600 may proceed to operation 615.

In 611, the processing devices 112 (e.g., the writing module 410) of the store servers may synchronize the data set to the slave server of the target server group. The slave server may store a portion or all of the data set. For example, the slave server may store the latest data set(s), or all the data sets in the master server. In some embodiments, the master server may send a write request for writing the data set(s) to the slave server; if the slave server is operating properly, the slave server may respond to the master server. In some embodiments, the master server may transmit the data set(s) to the slave server, and the slave server may write the data set(s) into the slave server.

In 613, the processing devices 112 (e.g., the reading module 408) of the consumer computing device may read the data set from the slave server of the target server group. In some embodiments, the consumer computing device may communicate with and/or be connected to the slave server of the target server group directly (e.g., via a data cable) or via the network 120, to read the data set(s) stored in the slave server. In some embodiments, the consumer computing device may send a read request to the slave server of the target server group; if the slave server is operating properly, the slave server may respond to the consumer computing device, and the consumer computing device may read data from the slave server. In some embodiments, the data read from the slave server may include part or all of the data set(s). In some embodiments, the data first stored in the slave server may be first read by the consumer computing device.

In 615, the processing devices 112 (e.g., the reading module 408) of the consumer computing device may read the data set from the master server of the target server group. In some embodiments, the consumer computing device may read a portion or all of the data set(s) stored in the master server. For example, the consumer computing device may read the latest data stored in the master server, all the data set(s) stored in the master server, or the like.

In 617, the processing devices 112 (e.g., the configuring module 414) of the proxy servers may initiate a new server to couple with the master server of the target server group, and use the new server as a slave server of the target server group. In some embodiments, the processing devices 112 may initiate the new server from the servers 110. For example, the processing devices 112 may determine an idle server in the servers 110 as the new server. In some embodiments, the processing devices 112 may configure the new server by performing, e.g., configuration file(s) on the new server, so that the new server and the master server are configured as a server group, and the new server is used as a slave server.

In 619, the processing devices 112 (e.g., the determining module 404) of the proxy servers may determine whether the slave server of the target server group is operating properly. More descriptions of the determination of the operating states of the slave server may be found elsewhere in the present disclosure (e.g., operation 609 in FIG. 6A and the description thereof). In response to a determination that the slave server of the target server group is operating properly, the process 600 may proceed to operation 621. In response to a determination that the slave server of the target server group is operating improperly, the process 600 may proceed to operation 629.

In 621, the processing devices 112 (e.g., the transmitting module 406) of the proxy servers may transmit the data set to the slave server of the target server group. In some embodiments, the processing devices 112 may directly transmit the data set from the proxy servers to the slave server via one or more data cables connecting the proxy servers and the slave server. In some embodiments, the processing devices 112 may transmit the data set from the proxy servers to the slave server via the network 120.

In 623, the processing devices 112 (e.g., the writing module 410) of the store servers may store the data set in the slave server of the target server group.

In 625, the processing devices 112 (e.g., the reading module 408) of the consumer computing device(s) may read the data set from the slave server of the target server group. In some embodiments, the consumer computing device may communicate with and/or be connected to the slave server in the target server group directly (e.g., via a data cable) or via the network 120. In some embodiments, the consumer computing device may send a reading request to the slave server; the slave server may respond to the consumer computing device, and/or transmit the data set to the consumer computing device. In some embodiments, the processing devices 112 may read a portion or all of the data set(s) stored in the slave server of the target server group.

In 627, the processing devices 112 (e.g., the configuring module 414) of the proxy servers may initiate a new server to couple with the slave server of the target server group, and use the new server as a master server of the target server group. In some embodiments, the processing devices 112 may initiate the new server from the servers 110. For example, the processing devices 112 may determine an idle server in the servers 110 as the new server. In some embodiments, the processing devices 112 may configure the new server by performing e.g., configuration file(s) on the new server, so that the new server and the master server are configured as a server group, and the new server is used as a master server.

In 629, the processing devices 112 (e.g., the determining module 404) of the proxy servers may determine another server group or initiating a new server group for storing the data set. In some embodiments, the processing devices 112 may determine another server group from a plurality of present server groups. For example, the processing devices 112 (e.g., the determining module 404) may determine an idle server group in the plurality of sever groups and use the idle server group as the target server group. In some embodiments, the processing devices 112 (e.g., the configuring module 414) may initiate a new server group from the servers 110 for storing the data set. For example, the processing devices 112 may determine two idle servers among the servers 110, and configure the two idle servers by performing, e.g., configuration file(s) on the two idle servers, so that the two idle servers are configured as a server group, in which one of the two idle servers is used as a master server, and the other one of the two idle servers is used as a slave server.

It should be noted that the above description is merely provided for the purpose of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, one or more operations may be added elsewhere in the process 600. For example, a storing operation may be added after operation 613, 615, and/or 625. In the storing operation, the processing devices 112 (e.g., the writing module 410) of the consumer computing device(s) may store the data set(s) in a database operated by a storage device. As another example, after operation 629, the processing devices 112 may use the newly determined server group as the target server group, and the process 600 may return to 605, and then one or more of operations 605 through 617 may be performed.

FIG. 7 is a flowchart illustrating an exemplary process for storing data sets into a database according to some embodiments of the present disclosure. The process 700 may be executed by the data storage system 100. For example, the process 700 may be implemented as a set of instructions stored in the storage ROM 230 or RAM 240. The processor 220 and/or the modules in FIG. 4 may execute the set of instructions, and when executing the instructions, the processor 220 and/or the modules may be configured to perform the process 700. The operations of the illustrated process presented below are intended to be illustrative. In some embodiments, the process 700 may be accomplished with one or more additional operations not described and/or without one or more of the operations discussed. Additionally, the order in which the operations of the process 700 illustrated in FIG. 7 and described below is not intended to be limiting.

In 701, the processing devices 112 (e.g., the acquisition module 402) of the proxy servers may receive a plurality of write requests for writing a plurality of data sets to a persistent data storage. In some embodiments, the plurality of write requests may be generated by one or more data generation servers and transmitted to the proxy servers. In some embodiments, the plurality of write requests may be concurrent write requests. More descriptions of the write requests and/or the receiving of the write requests may be found elsewhere in the present disclosure (e.g., operation 501 in FIG. 5 and the description thereof).

In 703, the processing devices 112 (e.g., the determining module 404) of the proxy servers may determine a target server group among a plurality of server groups for each data set. In some embodiments, the proxy servers may determine the target server groups based on an identification number associated with the each data set, and/or operating states of the plurality of server groups. In some embodiments, as illustrated in operation 501 of FIG. 5, the proxy servers may generate an identification number for each data set using one or more algorithms (e.g., a hash algorithm). In some embodiments, the identification numbers may be generated based on characteristics of the data sets or the descriptions of the contents that are requested to be written.

In some embodiments, the proxy servers may determine the target server groups based on the identification number associated with the each data set, and/or the operating states of the plurality of server groups. In some embodiments, the proxy servers may determine available server groups (e.g., server groups that are not working at full capacity, server groups that are working properly, or server groups that have available storage spaces or computing resources) among the plurality of server groups based on the operating states of the plurality of server groups. In some embodiments, the proxy servers may identify a corresponding target server group (among the available server groups) that has current data with the same identification number as the each data set to be written. Alternatively, in some embodiments, the proxy servers may identify a corresponding candidate target server group (among the plurality of server groups) that has current data with the same identification number as the each data set to be written, and then the proxy servers may determine corresponding available target server group(s) based on the operating states of the plurality of server groups. In some embodiments, if a data set has no corresponding available target server group, or the identification number of the data set are identical to none of the plurality of server groups, the proxy servers may initiate a new server group for storing the data set, as illustrated in operation 629 of FIG. 6B. In this way, the data sets that have the same identification number can be transmitted to the same server group, or the data sets transmitted to the same server group may have the same identification number, which can retain the sequence of a data stream of the plurality of data sets.

In 705, the processing devices 112 (e.g., the transmitting module 406) of the proxy serves may transmit each data set to a corresponding target server group. In some embodiments, the target server group may include a master server and a slave server. In some embodiments, if the master server of the target server group is operating properly, the proxy servers may transmit the each data set to the master server of the corresponding target server group. If the master server of the target server group is operating improperly, and the slave server of the target server group is operating properly, the proxy servers may transmit the each data set to the slave server of the corresponding target server group. More descriptions of the transmission of the data set(s) to the target server group(s) may be found elsewhere in the present disclosure (e.g., FIGS. 6A and 6B and descriptions thereof).

In 707, the processing devices 112 (e.g., the writing module 410) of the store servers may store each data set in a corresponding target server group. In some embodiments, the processing devices 112 may store each data set in a master server and a slave server of the corresponding target server group asynchronously, which can improve a concurrent writing capacity and the stability of the data storage system 100. More descriptions of the storage of the data set(s) in the target server group(s) may be found elsewhere in the present disclosure (e.g., FIGS. 6A and 6B and descriptions thereof).

In 709, the processing devices 112 (e.g., the reading module 408) of the consumer computing devices may read data stored in the plurality of server groups. The data read by the consumer computing devices may include part or all of the plurality of data sets, and/or data that is already stored in the plurality of server groups. In some embodiments, each of the plurality of server groups may be coupled to a corresponding consumer computing device. In some embodiments, each consumer computing device may send a read request to a corresponding server group; the corresponding server group may respond to the each consumer computing device; and/or the each consumer computing device may read the data from the corresponding server group. In some embodiments, as illustrated in operation 613 or 625 of FIG. 6A, the consumer computing device may read data from the slave serer of the corresponding server group. In some embodiments, as illustrated in operation 615 of FIG. 6A, the consumer computing device may read data from the master server of the corresponding server group. In some embodiments, a number or count of the consumer computing devices may be adjusted according to, for example, reading speed(s) of the consumer computing device(s) for reading data from the server group(s), reading and/or writing speed(s) of the consumer computing device(s) for writing data to other device(s) (e.g., a database operated by a storage device).

In 711, the processing devices 112 (e.g., the writing module 410) of the consumer computing devices may write the data to a database being operated by the persistent data storage. More descriptions of the writing of the data to the database may be found elsewhere in the present disclosure (e.g., operation 509 in FIG. 5 and description thereof).

It should be noted that the above description is merely provided for the purpose of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, one or more operations may be added elsewhere in the process 700. For example, one or more operations illustrated in FIG. 8 may be added in process 700.

FIG. 8 is a flowchart illustrating an exemplary process for monitoring data storage according to some embodiments of the present disclosure. The process 800 may be executed by the data storage system 100. For example, the process 800 may be implemented as a set of instructions stored in the storage ROM 230 or RAM 240. The processor 220 and/or the modules in FIG. 4 may execute the set of instructions, and when executing the instructions, the processor 220 and/or the modules may be configured to perform the process 800. The operations of the illustrated process presented below are intended to be illustrative. In some embodiments, the process 800 may be accomplished with one or more additional operations not described and/or without one or more of the operations discussed. Additionally, the order in which the operations of the process 800 illustrated in FIG. 8 and described below is not intended to be limiting.

In 801, the processing devices 112 (e.g., the monitoring module 412) of a monitor may monitor operating state(s) of the master server(s) of the server group(s) (e.g., the target server group illustrated in FIGS. 5-7, the plurality of server groups illustrated in FIG. 7), the slave server(s) of the server group(s), and/or the consumer computing device(s). In some embodiments, the monitoring of the operating state(s) of the master server(s), slave server(s), and/or the consumer computing device(s) may be similar to the determination of the operating state of the master server described in operation 603 of FIG. 6A. For example, the processing devices 112 may determine the operating states of the master server(s), the slave server(s), and/or the consumer computing device(s) by monitoring data flow rate(s), conditions of external device(s) connected to the master server(s), the slave server(s), the consumer computing device(s), or the like. In some embodiments, the processing devices 112 may monitor the operating state(s) based on corresponding log file(s). For example, the processing devices 112 may monitor the operating state(s) of the master server(s) based on log file(s) of the master server(s). As another example, the processing devices 112 may monitor the operating state(s) of the slave server(s) based on log file(s) of the slave server(s). As a further example, the processing devices 112 may monitor the operating state(s) of the consumer computing device(s) based on log files(s) of the consumer computing device(s).

The monitor may be configured to monitor the operating state(s) of the servers 110 (e.g., the master server(s), the slave server(s), the proxy servers, the consumer computing device(s), etc.). The data storage system 100 may generate one or more corresponding log files for each of the servers 110. A log file may record information relating to a server. The information may include request information (e.g., write request(s), read request(s), etc.), error information, time information, or the like, or any combination thereof. In some embodiments, the servers 110 may record events of the servers 110, the request information, abnormal state(s) of the servers 110, or the like, in corresponding log file(s). In some embodiments, the servers 110 may report the log file(s) or information recorded in the log file(s) to an administrator of the data storage system 100. In some embodiments, if one or more of the servers 110 are not operating properly (or in abnormal states), the administrator may identify reason(s) and/or time(s) of the abnormal states.

In 803, the processing devices 112 (e.g., the determining module 404) may determine whether a data backlog is present in the server group(s) based on the monitoring result.

In some embodiments, the processing devices 112 may determine a difference value between the amount (or transmission rate) of the data sets transmitted from the proxy servers to the server groups and the amount (or transmission rate) of the data sets read from the server group(s) by the consumer computing devices based on the monitoring result. If the difference value is greater than a preset value, the processing devices 112 may determine that the data backlog is present in the server group(s), otherwise the processing devices 112 may determine that the data backlog is not present in the server group(s). In some embodiments, the processing devices 112 may determine a difference value between the amount (or transmission rate) of the data set(s) transmitted from the proxy servers to each server group and the amount (or transmission rate) of the data set(s) read from the each server group by a corresponding consumer computing device based on the monitoring result. If the difference value is greater than a preset value, the processing devices 112 may determine that a data backlog is present in the each server group, otherwise the processing devices 112 may determine that the data backlog is not present in the each server group. In some embodiments, if a consumer computing device does not finish reading all the data sets stored in a corresponding server group within a preset time, the processing devices 112 may determine that a data backlog is present in the server group.

In 805, in response to a determination that a data backlog is present in the server group(s), the processing devices 120 (e.g., the configuring module 414) may adjust data reading and/or writing speed(s) of the consumer computing device(s) and/or initiate another consumer computing device to share a workload of the consumer computing device(s). In some embodiments, the processing devices 112 may adjust the data reading and/or writing speed(s) based on a data writing status of the current consumer computing device(s). The data writing status may indicate the amount of data needed to be written to the server groups from the proxy servers, a data reading and/or writing speed for writing the data from the proxy servers to the server groups, the amount of the data needed to be written from the server groups to a database, the number or count of effective consumer computing devices that can read and/or write the data, the speed of each of the consumer computing devices for reading and/or writing the data, etc.

In some embodiments, the data backlog may occur due to a limited space of the database to which the current consumer computing device(s) write the data, abnormal state(s) of the current consumer computing device(s), limited reading and/or writing speed(s) of the current consumer computing device(s), or the like. Accordingly, in some embodiments, the processing devices 120 may control or adjust the data reading and/or writing speed(s) of the consumer computing device(s) based on the current data writing status. In some embodiments, the processing devices 120 may control or adjust the data reading and/or writing speed(s) of the current consumer computing device(s) by performing one or more configuration file(s) on the current consumer computing device(s). In some embodiments, the processing devices 112 may initiate one or more other consumer computing device(s) to share a workload of the current consumer computing device(s). For example, the processing devices 112 may determine an idle server in the servers 110 as a new consumer computing device. In some embodiments, the processing devices 112 may initiate the new consumer computing device by performing one or more configuration file(s) on the new consumer computing device.

It should be noted that the above description is merely provided for the purpose of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, one or more operations may be added elsewhere in the process 800. For example, if all the data in a server group is written to the database operated by the persistent data storage, and an idle time of the server group is larger than a threshold, the server group may be decoupled from the proxy servers, the corresponding current consumer computing device may be decoupled from the server group, and the decoupled server group and decoupled current consumer computing device may be identified as idle servers in the servers 110. The idle servers may be further initiated as proxy servers, master servers, slave servers, and/or consumer computing devices, if the current servers in the data storage system 100 are working overload or working improperly.

FIG. 9 is a schematic diagram illustrating an exemplary system for data storage according to some embodiments of the present disclosure. In some embodiments, the system 900 may include a queue system, for example, a distributed queue system. The system 900 may be configured to write a plurality of data sets. For example, the system 900 may be used to concurrently and/or persistently store the plurality of data sets to a persistent data storage (or a database operated by the persistent data storage). As illustrated in FIG. 9, the system 900 may include a proxy layer, a store layer, a plurality of consumers (also referred to as consumer computing devices), a Hadoop database (Hbase) operated by a persistent data storage, and a monitor. At least one of the proxy layer, the store layer and the consumers may be distributed.

In some embodiments, the proxy layer may include a plurality of proxy servers (e.g., a proxy server A, a proxy server B, . . . , a proxy server N, etc.). The plurality of proxy servers may be distributed. The proxy layer may communicate with or be connected to one or more data generation servers (and/or the terminal device(s) 130) directly (e.g., via one or more data cables) or via the network 120. For example, the proxy servers may receive a plurality of write requests from the terminal device(s) 130. In some embodiments, the write requests may be generated by one or more data generation servers (not shown in FIG. 9). In some embodiments, the terminal device(s) 130 and/or the data generation servers may randomly determine one or more proxy servers to respond to the write requests. In some embodiments, the terminal device(s) 130 may determine one or more proxy servers to respond to the write requests using one or more algorithms (e.g., a (dynamic) load balancing algorithm). The proxy servers in the proxy layer may communicate with or be connected to the server groups in the store layer. In some embodiments, the proxy servers may respond to the write requests and transmit the data sets to be written (requested in the write request) to the store servers in the store layer.

The store layer may receive the write request(s) transmitted from the proxy servers in the proxy layer, and/or store the data sets transmitted from the proxy servers. In some embodiments, the store layer may include a plurality of server groups, e.g., a server group A, a server group B, a server group C, . . . , a server group N, etc. In some embodiments, the proxy servers may generate an identification number for each of the data sets. In some embodiments, data sets having the same identification number may be transmitted to a same server group. For example, the proxy server B may transmit a portion of the data sets that have an identification number x₁ to the server group A, a portion of the data sets that have an identification number x₂ to the server group B, a portion of the data sets that have an identification number x₃ to the server group C, and a portion of the data sets that have an identification number x₄ to the server group N. Each server group may include a master server and a slave server. In some embodiments, the master server and the slave server may store duplicated copies of data asynchronously.

The consumers may communicate with or be connected to the server groups, respectively. In some embodiments, each consumer may be coupled to a corresponding server group. The consumers may communicate with or be connected to the Hbase. The consumers may read data from the server groups, and write the data to the Hbase. In some embodiments, a consumer may read data stored in a master server of a corresponding server group. In some embodiments, the consumer may read data store in a slave server of a corresponding server group. More descriptions of the data communication between the proxy servers, store servers, and the consumers may be found elsewhere in the present disclosure (FIGS. 6A and 6B and descriptions thereof).

The Hbase may be configured to store the data read from the plurality of consumers. In some embodiments, the Hbase may be operated by a persistent data storage. In some embodiments, the persistent storage may include but not limit to a ROM, a flash memory, a floppy disk, a magnetic disk, an optical disk, a hard disk drive, a solid-state drive, or the like, or any combination thereof. In some embodiments, the persistent data storage may be set in an Internet Data Center (IDC).

In some embodiment, the monitor may communicate with and/or be connected to the server groups and/or the consumers. In some embodiments, all operations of the proxy servers, the server groups, the consumers may be recorded in corresponding log files. The monitor may monitor operating states of master servers of the server groups, slave servers of the server groups, and/or the consumers based on, e.g., corresponding log files thereof. In some embodiments, the system 900 may adjust the data reading and/or writing speed of the consumers based on the monitoring result by, for example, initiating another consumer, improving the reading and/or writing speed of the current consumers, or the like, or any combination thereof.

It should be noted that the above description is merely provided for the purpose of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, the system 900 may include one or more monitors to monitor the operating states of the components of the system 900. As another example, the monitor may monitor operating states of the proxy servers in the proxy layer.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “module,” “unit,” “component,” “device,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C #, VB. NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claim subject matter lie in less than all features of a single foregoing disclosed embodiment.

1. A method for storing data, comprising:
receiving, at a distributed proxy server from a data generation server, a write request for writing a data set to a persistent data storage;
transmitting, by the distributed proxy server, the data set to a target server group among a plurality of server groups, based on an identification number associated with the data set, each server group of the plurality of server groups including a master server and a slave server;
storing, by the target server group, the data set in the master server and the slave server asynchronously;
reading, by a consumer computing device coupled to the target server group, the data set from the target server group; and
writing, by the consumer computing device, the data set to a database being operated by the persistent data storage.

2. The method of claim 1, wherein the transmitting, by the distributed proxy server, the data set to a target server group comprises:
upon a determination that the master server of the target server group is operating properly,
transmitting, by the distributed proxy server, the data set to the master server of the target server group.

3. The method of claim 2, wherein the storing, by the target server group, the data set in the master server and the slave server asynchronously comprises:
upon a determination that the slave server of the target server group is operating properly,
storing, by the master server of the target server group, the data set in the master server of the target server group; and
synchronizing, by the master server of the target server group, the data set to the slave server of the target server group.

4. The method of claim 3, wherein the data set is read by the consumer computing device from the slave server of the target server group.

5. The method of claim 2, wherein the storing, by the target server group, the data set in the master server and the slave server asynchronously comprises:
upon a determination that the slave server of the target server group has failed,
storing, by the master server of the target server group, the data set in the master server of the target server group.

6. The method of claim 5, wherein the data set is read by the consumer computing device from the master server of the target server group.

7. The method of claim 5, further comprising:
initiating a new server to couple with the master server of the target server group, and using the new server as a slave server of the target server group.

8. The method of claim 1, wherein the transmitting, by the distributed proxy server, the data set to a target server group comprises:
upon a determination that the slave server of the target server group is operating properly and the master server of the target server group has failed,
transmitting, by the distributed proxy server, the data set to the slave server of the target server group.

9. The method of claim 8, further comprising:
initiating a new server to couple with the slave server of the target server group, and using the new server as a master server of the target server group.

10. The method of claim 8, wherein the data set is stored by the slave server of the target server group in the slave server of the target server group.

11. The method of claim 10, wherein the data set is read by the consumer computing device from the slave server of the target server group.

12. The method of claim 1, further comprising:
monitoring an operating state of the master server of the target server group, the slave server of the target server group, or the consumer computing device based on one or more corresponding log files generated by the master server of the target server group, the slave server of the target server group, or the consumer computing device.

13. The method of claim 12, further comprising:
determining whether a data backlog is present in the target server group based on the monitoring result; and
in response to a determination that a data backlog is present in the target server group,
adjusting a data reading or writing speed of the consumer computing device based on a data writing status, or
initiating another consumer computing device to share a workload of the consumer computing device.

14. The method of claim 1, further comprising:
receiving, from the database, a data writing status; and
adjusting a data reading or writing speed of the consumer computing device based on the data writing status.

15. The method of claim 1, wherein the database is a Hadoop database (Hbase).

16. A method for storing data, comprising:
receiving, at a distributed proxy server from a data generation server, a plurality of write requests for writing a plurality of data sets to a persistent data storage, each data set having a corresponding identification number;
determining, by the distributed proxy server, a target server group among a plurality of server groups for each data set based on the identification number of the data set and operating states of the plurality of server groups;
transmitting, by the distributed proxy server, each data set to a corresponding target server group, such that data sets having the same identification number are transmitted to a same target server group;
storing, each data set in a corresponding target server group;
reading, by a plurality of consumer computing devices, data stored in the plurality of server groups, each consumer computing device being coupled to one of the plurality of server groups, the each consumer computing device being configured to read a portion of the data from a coupled server group, the data including part or all of the plurality of data sets; and
writing, by the plurality of consumer computing devices, the data to a database being operated by the persistent data storage.

17. The method of claim 16, further comprising:
in response to a determination that the identification number of a first data set of the plurality of data sets is not identical to the identification numbers of the current data stored in the plurality of server groups, or the plurality of server groups are not available,
initiating a new server group to store the first data set.

18. The method of claim 16, wherein the plurality of write requests are concurrent write requests.

19-20. (canceled)

21. The method of claim 16, wherein each data set is stored in a master server and a slave server of a corresponding target server group asynchronously.

22-34. (canceled)

35. A system for storing data, comprising: one or more distributed proxy servers, a plurality of server groups, and one or more persistent data storages, wherein:
one of the one or more distributed proxy servers is configured to:
receive, from a data generation server, a write request for writing a data set to a persistent data storage; and
transmit the data set to a target server group among the plurality of server groups, based on an identification number associated with the data set, each server group of the plurality of server groups including a master server and a slave server;
the target server group of the plurality of server groups is configured to store the data set in the master server and the slave server asynchronously, wherein:
the data set is read by a consumer computing device coupled to the target server group and written by the consumer computing device to a database being operated by the one or more persistent data storages.

36-38. (canceled)
